(19) United States
(12) Patent Application Publication
(10) Pub. No.: US 2007/0257429 A1
(43) Pub. Date: Nov. 8, 2007

(54) Casino related event betting

(76) Inventors: Steven N. Kane, Brookline, MA (US); Dow Hardy, Marlborough, MA (US); Mark E. Hermann, Wellesley, MA (US); Paul LaRocca, Westport, MA (US); Bijan Sabet, Sudbury, MA (US)

Correspondence Address: LOWRIE, LANDO & ANASTASI, RIVERFRONT OFFICE, ONE MAIN STREET, ELEVENTH FLOOR, CAMBRIDGE, MA, 02142, US

(21) Appl. No.: 11/388,189

(22) Filed: Mar. 23, 2006

Related U.S. Application Data
(60) Provisional application No. 60/664,356, filed on Mar. 23, 2005.

(51) Int. Cl. G06F 19/00

(52) U.S. Cl. 273/138.1

(57) ABSTRACT

A system and methods for betting on casino related games, events or actions. There is a present and recurring need for new bet types that may increase excitement for players and that may be advantageous to both the bettor and to the bet-taking establishment. According to one example, casino-related events may include casino game-related events and events related to other activities of the casino. For example, casino game-related events may include predicting the outcome of a particular game, predicting whether or not a given slot machine will pay out a jackpot in excess of a given amount (e.g., $5,000) within a given time period, predicting how many people will win more than a given amount at blackjack on a particular day or during some other time period, and many other events. Events associated with casino games may be related to any game played at the casino including, but not limited to keno, bingo, poker, blackjack, slots, baccarat, and roulette. According to example, non-game-related events may be associated with anything occurring at the casino, such as, but not limited to, events related to entertainment at the casino (e.g., whether a performer will miss a show in the next month due to the flu), ratings (e.g., does the casino resort obtain four stars in the next Mobil guide), or foot traffic (e.g., when will the one millionth person visit the casino). Any event that will have a known, unambiguous outcome at some point in time may provide the basis for a bet. In one example, bets may be placed upon any casino-related event that occurs randomly.

### RELATED APPLICATIONS

This application claims priority under 35 U.S.C. §119(e) to U.S. Provisional Application Ser. No. 60/664,356 entitled “CASINO RELATED EVENT BETTING” filed on Mar. 23, 2005, which is herein incorporated by reference in its entirety.

### FIELD OF THE INVENTION

The invention relates generally to systems and methods for betting on casino game events or actions.

### BACKGROUND

Betting on sports and other events is a multi-billion dollar business for casinos and Internet-based gaming operations around the world. Land-based casinos have large sports and event betting parlors for attracting bettors. These parlors display the bets that a person may make on various sports or events. Most major sports may be bet on, including professional and college football, soccer, baseball, basketball, auto racing, and ice hockey, as well as cricket, rugby, and various sports tournaments such as, for example, the NCAA Men's and Women's Basketball Championships and the soccer World Cup tournament. In addition, bets may be placed on other events such as, betting on who will be the winner of a reality television show (e.g., the Survivor reality show), betting on when the first person might land on Mars, or betting on who will be the winner of the next United States Presidential election.

Land-based casinos generally require that the bettors place their bets and pay for them on-site. It is thought that sports and event bettors will, as a result of coming to the casino to place bets, be motivated to play other games at the land-based casino. For some casinos, bets may also be placed at kiosks located throughout the casino so that the bettor need not go too far from where they may be playing other games. Presently, a few land-based casinos take sports and event bets completely over the Internet, where the bettor makes and pays for the bet on-line. Additionally, websites existing exclusively for on-line betting and numerous Internet-only casinos (with no land-based counterpart) now take bets on sports and other events.

There is a present and recurring need for new bet types that may increase excitement for players and that may be advantageous to both the bettor and to the bet-taking establishment.

### SUMMARY

According to various aspects and embodiments of the invention, a system and method is provided for permitting a player to bet on a variety of casino related events, such as casino game outcomes, player statistics and other events that may occur at a casino. In particular, a bet may be placed by a player upon the occurrence or non-occurrence of a casino related event. The event may be related to a casino game, such as slots. For example, a bet may be placed as to whether or not any one or more slot machines will pay out a particular sum over a game period (e.g., a payout over $5,000 on a given evening), or any other game related event or combination thereof.

In one example, the bet may be placed by a bettor either within a casino or remotely using electronic methods, such as e-mail, Internet, etc. The bet may be paid for using, for example, cash, credit card or loyalty points. In another example, winnings for the bet may be paid using money, casino chips or loyalty points. According to one embodiment, the bettor may subscribe to play the same bet for more than one specified time period, and the subscription may automatically renew.

According to one embodiment, a casino, game operator, or computer system may automatically determine whether the bet is a winning bet, and may automatically notify the bettor of the winning bet. In one example, notification may occur using any electronic means, including by an e-mail message, by the Internet, by a telephone, or by a text message.

In one example, the bet has odds that are set when the bet is paid for. Alternatively, the bet may have odds that change as the specified time period approaches. For example, the bet may have odds that change as time elapses after the previous time the specified casino related event occurred.

According to one embodiment, there is provided a method of gaming comprising acts of defining a casino-related event, defining odds of the casino-related event occurring, and recording a bet on whether or not the casino-related event will occur. Defining a casino-related event may specify the event that must occur, the type of game, and a time period during which the event must occur for the bettor to win. In addition, the bet may identify one or more particular tables or machines offering the specified game to which the bet will apply. In one embodiment, the method of gaming further comprises acts of determining if the bet is a winning bet and providing a payout for the winning bet based on the defined odds. In one embodiment, the casino-related event is not game related. In one embodiment, the casino-related event involves a game offered by a casino. In one embodiment, the game includes slots. In one embodiment, the act of recording a bet includes allowing a bettor to place a bet remotely. In one embodiment, the act of recording a bet includes allowing a bettor to place a bet within a casino, wherein the method is a computer-implemented method and the method further comprises performing by a casino-event monitoring system acts of tracking the casino-related event, determining if the casino-related event occurred, and providing a payout to a bettor based on the defined odds. In one embodiment, the method of gaming further comprises an act of recording a subscription for a bet that allows a bettor to play a particular bet over at least one specified time period. In one embodiment, the subscription automatically renews. In one embodiment, the act of defining odds of the casino-related event occurring includes adjusting the odds over time.

According to another embodiment, there is provided a betting system comprising means for defining a casino-related event, means for recording a bet related to occurrence of the casino-related event. In one embodiment, the casino-related event is not game related. In one embodiment, the casino-related event involves a game offered by a casino. In one embodiment, the game includes slots. In one embodiment, the betting system further comprises means for determining whether the bet is a winning bet. In one embodiment, the betting system further comprises means for notifying the bettor of the results of the bet. In one embodiment, the betting system further comprises means for subscribing to play a bet for at least one time period. In one embodiment, the betting system further comprises means for determining odds of the casino-related event. In one embodiment, the betting system further comprises means for submitting a bet proposal by a bettor.

According to another embodiment, a computer-readable medium is provided having computer-readable signals stored thereon that define instructions that, as a result of being executed by a computer, instruct the computer to perform a method for gaming. In one embodiment the method comprises act of defining a casino-related event, defining odds of the casino-related event occurring, and recording a bet on whether or not the casino-related event will occur. In one embodiment, the method further comprises acts of determining if the bet is a winning bet and providing a payout for the winning bet based on the odds. In one embodiment, the casino-related event is not game related. In one embodiment, the casino-related event involves a game offered by a casino. In one embodiment, the game includes slots. In one embodiment, the act of recording a bet includes allowing a bettor to place a bet remotely. In one embodiment, the act of recording a bet includes allowing a bettor to place a bet within a casino. In one embodiment, the method further comprises an act of recording a subscription for a bet that allows a bettor to play a particular bet for at least one specified time period. In one embodiment, the subscription automatically renews. In one embodiment, the act of defining odds of the casino-related event occurring includes adjusting the odds over time.

Further features and advantages of the present invention as well as the structure and operation of various embodiments of the present invention are described in detail below with reference to the accompanying drawings. In the drawings, like reference numerals indicate like or functionally similar elements.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings,

FIG. 1 is a flow diagram illustrating one example of a procedure for betting on a casino related event according to aspects of the invention;

FIG. 2 is a block diagram illustrating one embodiment of a computer system according to aspects of the invention;

FIG. 3 is a block diagram of a general-purpose computer system upon which various embodiments of the invention may be implemented; and

FIG. 4 is a block diagram of a computer data storage system with which various embodiments of the invention may be practiced.

### DETAILED DESCRIPTION

Bettors often enjoy the lively atmosphere of a land-based casino when betting on sports or an event. Land-based casinos may generally foster this atmosphere by providing rooms for viewing sports or other events and by hosting parties that attract many bettors. For example, a casino may host a party for a major sporting event such as the National Football League Super Bowl or the NCAA Men's Basketball Championship. It may be beneficial and desirable for land-based casinos to attract sports and other event bettors so as to increase foot traffic through the casino and to potentially increase gaming revenue. However, it is appreciated that betting on sports or other event at a casino may be inconvenient for a bettor as the bettor must go to the land-based casino to find out the bets taken and the odds. Therefore, it is likely that people wishing to bet on sports or other events may go to the land-based casino only if they are certain that they want to place a bet on a specific event or sports activity. By contrast, with the advent of Internet betting sites and on-line casinos, a bettor may easily obtain information relating to betting opportunities and odds. Therefore, land-based casinos may be at a comparative disadvantage in ability to attract bettors.

To keep existing bettors coming back to a land-based casino and to attract new bettors, new and exciting betting opportunities may be desirable. Therefore, according to at least one aspect of the invention, there is provided a system and method for betting on casino-related events, as discussed further below. It is to be appreciated that although the following discussion may refer primarily to land-based casinos, the invention is not so limited and the principles of the invention may be applied equally to on-line casinos and gaming operations.

According to one embodiment, casino-related events may include casino game-related events and events related to other activities of the casino. For example, casino game-related events may include predicting the outcome of a particular game, predicting whether or not a given slot machine will pay out a jackpot in excess of a given amount (e.g., $5,000) within a given time period, predicting how many people will win more than a given amount at blackjack on a particular day or during some other time period, and many other events. Events associated with casino games may be related to any game played at the casino including, but not limited to keno, bingo, poker, blackjack, slots, baccarat, and roulette.

According to one embodiment of the present invention, the player may be permitted to place bets on events related to a casino slot machine game. Such a game and associated events may relate to a game in which the player is participating. According to another embodiment, the player may be permitted to wager on an outcome not associated with play of the slot machine game by the player. That is, the player may be permitted to wager on games played by other players.

As discussed, one aspect of the present invention relates to permitting a player to place a bet involving a casino-based event involving play of one or more slot machine games by one or more players.

Some examples of bets that may be placed on slot machine action include:
Does a specific slot machine hit a jackpot larger than $1000 during a specific thirty minute time period?
What is the total jackpot paid out by a specific slot machine during a specific 24 hour time period?
What is the total money bet on a specific group of slot machines during a specific one month time period?
When does the next one million dollar payout occur on any slot machine in the casino?
How many times does a specific symbol come up on the center pay line on a specific reel on a specific slot machine within a specific two day time period?

A typical slot machine-type game may include a display of a computer system upon which the game is played. A slot machine representation on the computer system may be rendered in an interface, with the slot machine having reels having one or more indicia located on one or more reels. The indicia may be, for example, characters, items, or any other type of elements suitable for use in a slot machine.

A set of indicia across the reels along one or more lines may correspond to a combination of indicia that are matched to a payout in a pay table. The pay table may indicate, for instance, a correlation between combinations of indicia and awarded payout (or credit) totals. In one example above, such indicia may include types of fruits, when matched in a particular combination. If the indicia across one or more lines match that indicated by the pay table, the player playing the slot machine game may be awarded a corresponding payout as indicated by the pay table.

The slot machine representation may also include a spin control which may be any type of control (e.g., a button, level, etc.) that, when activated, causes the slot machine reels to spin. Further, the interface may also include a spin indicator that indicates the number of spins remaining for the player. Thus, the interface may include a counter that indicates the current accrued payout or other credits won by the player.

The type and layout of the slot machine is not limited to the type and layout described. Rather, it should be appreciated that the slot machine may be any type and layout. Typically, a slot machine game ends when the player runs out of spins.

In one example, a bettor places a bet specifying a particular slot machine and a particular result that the bettor expects to happen during a specific time period. The slot machine is monitored by the same or a different computer system that is conducting the slot machine game. In the alternative, a player may play a slot machine game over the Internet. During the course of Internet play, the slot machine game result is monitored by the same or a different computer system. Based on the monitored result, a determination is made on the outside bet that was dependent on the result of the slot machine game. The monitoring computer system acts on the results of the monitored game by causing the bettor to be compensated if the bet on result occurred, and the monitoring computer system acts by not compensating the bettor if the bet on result did not occur.

According to another embodiment, a bet may be placed on an event that is based, at least in part, on events occurring in one or more slot machine game instances played by one or more players as played on one or more slot machines. Thus, the casino-based event may be dependent on more than one result relating to any number of slot machine games and/or players.

Similar bets may also be placed on events associated with other casino games. In general, a game related event bet may specify the event that must occur, the type of game, and a time period during which the event must occur for the bettor to win. In addition, the bet may identify one or more particular tables or machines offering the specified game to which the bet will apply.

According to another embodiment, non-game-related events may be associated with anything occurring at the casino, such as, but not limited to, events related to entertainment at the casino (e.g., whether Wayne Newton will miss a show in the next month due to the flu), ratings (e.g., does the casino resort obtain four stars in the next Mobil guide), or foot traffic (e.g., when will the one millionth person visit the casino). Any event that will have a known, unambiguous outcome at some point in time may provide the basis for a bet. In one example, bets may be placed upon any casino-related event that occurs randomly.

In one embodiment, the casino or game operator may select a variety of games and events upon which a bettor may place a bet. According to one embodiment, a bettor may also be able to propose a bet to a casino or game operator for consideration, thereby potentially increasing the variety of available bets and the interest and/or excitement for the bettor.

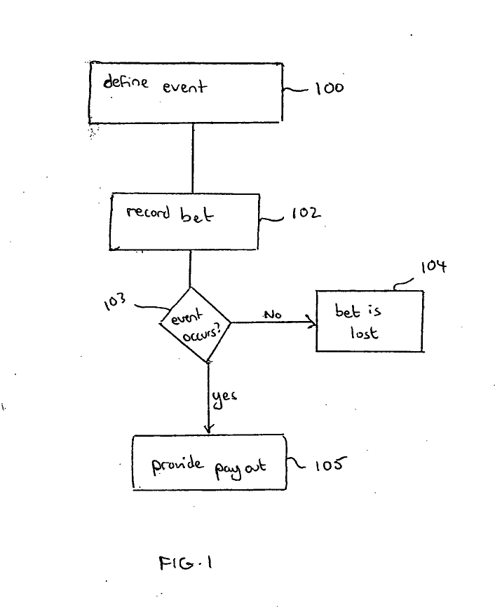

Referring to FIG. 1, to begin an event-betting procedure, the event being bet upon may be defined (step 100). The event may be any event, game-related or non-game related, such as any of the examples given above. In addition, defining the event may also include defining odds of the event occurring. The event-betting procedure may be implemented on a computer system as described below.

The odds for a bet may be set or may be variable depending upon when the bet is made. For example, a bet on what day the next one million dollar slot machine will occur in the casino may have 90:1 payout immediately after a one million dollar slot payout is paid, but the payout may decrease for similar bets made as each day passes since the last one million dollar slot payout.

Referring again to FIG. 1, once the event is defined, a bettor may place a bet on the event and that bet may be recorded by the casino or game operator (step 102). A bettor may place the bet on-site at a casino, for example, at a cashier's desk or a kiosk, or remotely using, for example, the Internet, a phone, or other electronic methods known in the art.

When paying for a bet, a bettor may pay, for example, using money and/or loyalty points. In particular, a bettor may pay using money by debit card, credit card, check, cash or from an account credit either with the gaming operator or an affiliated organization. Alternatively, a bettor may pay using loyalty points from an account held either by the gaming operator or by an affiliated organization. Loyalty points may be obtained from any type of organization but are generally associated with loyalty programs such as frequent flier programs for airlines, frequent stay programs for hotels or frequent visitor programs for casinos. The bettor may pay a cashier in person, or may use other payment methods within the casino including, for example, by telephone, using a handheld device, or at an automated kiosk. Payment may be in any form that is legal in the particular jurisdiction.

In one embodiment of the invention, players may subscribe to make multiple consecutive bets. That is, the player pays at one time to play the same bet continuously. For example, a bettor may bet that the second reel on a specific slot machine will display a ‘cherry’ symbol on the center pay line ten times in one hour. With a subscription, the bettor may pay to make the same bet for the next ten hours, the next week, or any number of consecutive or non-consecutive specified timed periods. In another embodiment, the player may also choose to have his or her subscription automatically renewed for a predetermined time period.

Referring again to FIG. 1, once the specified time period during which the bet is valid has elapsed, a determination is made as to whether or not the event occurred, and thus whether or not the bet is a winning bet (step 103). It is to be appreciated that although FIG. 1 assumes a winning bet means that the event occurred, the invention is not so limited and an event may be defined such that non-occurrence of the event results in the bet being won by the bettor. According to one embodiment, the casino or game operator may automatically determine when a bettor is a winner. The result may be automatically authenticated and verified. The casino or game operator may then notify the bettor that he or she has won and what the winnings are. In one example, the bettor may be notified of a win by mail, e-mail, computer network, Internet, telephone, television, pager, fax, kiosk or any other method. After a winner is authenticated and verified, the casino or game operator may then notify all bettors of the win. Additionally, the casino or game operator may display any of the winning bet, the bettor's identity, and the payout.

When the bettor is paid for a win, a casino or game operator may pay using money and/or loyalty points (step 105). In particular, a bettor may be paid using money by debit card, credit card, check, cash, and/or may be given an account credit either with the casino, game operator, or affiliated organization. Alternatively, a bettor may gain loyalty points for an account held with the casino, game operator, or an affiliated organization. Loyalty points may be obtained for any type of organization but are generally associated with loyalty programs such as frequent flier programs for airlines, frequent stay programs for hotels, or frequent visitor programs for casinos. The payout may be in any form that is legal in the particular jurisdiction.

In one embodiment, a computer system may be used to operate most of the betting procedure, including taking, registering, and paying out bets. A computer system may include one or more computers that may be a supercomputer, a minicomputer, a mainframe, or a personal computer.

In one particular embodiment using casino slot machines, where the event being bet on involves casino slots, one or more results of a casino slot machine system may be used to determine a result of the bet-on event. Such a determination may be made, for example, by a computer system coupled to the slot machine game, by the slot machine system, or any combination thereof. A computer system used to run the betting operation may also include any combination of computer system types that cooperate to accomplish system-level tasks. Multiple computer systems may also be used to run the operation. The computer system also may include input or output devices, displays, or storage units. It should be appreciated that any computer system or systems may be used, and the invention is not limited to any number, type, or configuration of computer systems.

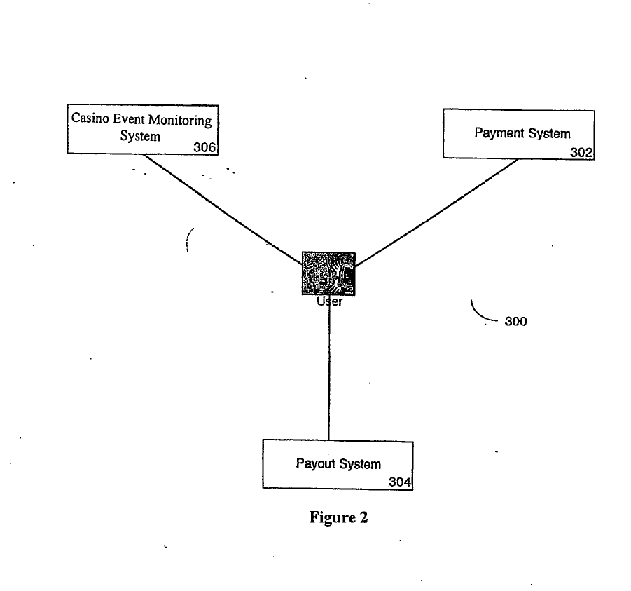

A computer system (e.g., computer system 300, FIG. 2) that may perform the betting system, its various embodiments, and that may execute the methods of gaming according to the various embodiments of the invention may include, for example, one or more component systems (e.g., systems 302, 304, and/or 306 as shown in FIG. 2). One system component (e.g., payment system 302) may handle payment, subscription and/or alternate method of entry (AMOE) by bettors to enter the betting sessions. Another system component (e.g., event monitoring system 306) may handle accepting bet proposals, may monitor a game that may be played on independent computer system, may handle running and viewing the betting session, and may handle the viewing of the progress of the monitored game. In one typical embodiment the monitored game is run on a separate computer system (not shown) that is monitored by the event monitoring system. Yet another system (e.g., payout system 304) may handle making payouts to players. Such a computer system may also be connected (e.g., by direct line or network) to other computer systems including systems for handling casino or hotel loyalty programs, reservations, in-room television viewing, gambling floor kiosks, or other systems. Connections to other computer systems may be performed using one or more of the system components described below.

The payment component 302 may include one or more of a number of well-known systems. For example, a bettor may be able to bet on one or more games using a telephone and speaking with a call center representative who inputs bettor, payment and subscription information manually into a computer using a user interface. In the computer, data may be stored in a data structure that is stored in a memory of the computer system. As used herein, a “data structure” is an arrangement of data defined by computer-readable signals. These signals may be read by a computer system, stored on a medium associated with a computer system (e.g., in a memory, on a disk, etc.) and may be transmitted to one or more other computer systems over a communications medium such as, for example, a network. Also as used herein, a “user interface” or “UI” is an interface between a human user and a computer that enables communication between a user and a computer. Examples of UIs that may be implemented with various aspects of the invention include a graphical user interface (GUI), a display screen, a mouse, a keyboard, a keypad, a track ball, a microphone (e.g., to be used in conjunction with a voice recognition system), a speaker, a touch screen, a game controller (e.g., a joystick), etc., and any combinations thereof.

Bettor information may also be entered into a payment system component (e.g., system 302). Bettor information that may be input includes name, address, telephone number, and age, and payment information may include credit or debit card number or loyalty account information. A similar system may exist for a bettor entering using the mail or a post card AMOE except the call center may be replaced by a mail center having representatives that enter information into one or more computers via a user interface. For example, a cashier who works at a casino directly with bettors that pay cash or credit to play, may also have the ability to input a bettor's, account, and subscription information for AMOE bettors using a user interface of a computer. In one embodiment, a bettor may receive or may purchase a membership card that stores bettor information and may be used to track a bettor's participation in bets. In one example, the membership card may be replaced by, or may include, for example, a hotel room keycard at a casino.

Computer systems or pay engines for handling electronic or online payment and subscriptions may also be used. Such systems are well known, and include such systems as PayPal, iKobo, Verisign, and other systems. Using such a system, a bettor interacts with a user interface to input information into a payment data structure that may be transferred to one or more payment systems (e.g., PayPal).

Various pay systems and one or more user interfaces may be located on computer systems coupled by a network with the computer system(s) storing data having bettor, account, and subscription information. As used herein, a “network” or a “communications network” is a group of two or more devices interconnected by one or more segments of transmission media or active communications equipment on which communications may be exchanged between the devices. Payout systems (e.g. payout system 304) are also well known. Any of a number of standard systems or payout engines for making payouts for winning may be used.

An event monitoring system (e.g., system 306 as shown in FIG. 2) according to one embodiment of the invention may comprise of a number of components for performing specific functions. These components may include, for example, storage devices that store data structures having information regarding casino-related events and odds. For example, such information may include event date, time, and location, bettor's betting and win/loss history, and casino-related event odds and their dependence upon time of payment.

A computer system may also include components to access payment and payout data structures. In one typical embodiment, the computer system operates by allowing a bettor to interact with the event monitoring system. The interaction may take the form of submitting a bet proposal, recording a bet, notifying a bettor of a win or loss, and initiating payout through another system component. The interaction may also take the form of observing the progress of a monitored game, and it may also take the form of reviewing a historical record of the monitored game. The interaction between a bettor and the event monitoring system may occur remotely or may take place at a land-based casino. The event monitoring system may take actions as a result of the interaction with the bettor. For example, the actions may include accepting a bet proposal, monitoring the event defined in the proposed bet, determining odds for the occurrence of the defined event, adjusting the odds over a time period, and determining based on monitoring the defined event whether or not the event occurred. The actions may include the act of notifying the bettor of a win or loss and arranging for payment in conjunction with other systems.

The process in FIG. 1 and the other methods according to various embodiments of the present invention, acts thereof and variations of those methods and acts, individually or in combination, may be defined by computer-readable signals tangibly embodied on a computer-readable medium, for example, a non-volatile recording medium, an integrated circuit memory element, or a combination thereof. Such signals may define instructions, for example, as part of one or more programs, that, as a result of being executed by a computer, instruct the computer to perform one or more of the methods or acts described herein, and/or various embodiments, variations and combinations thereof. Such instructions may be written in any of a plurality of programming languages, for example, Java, Visual Basic, C, C#, or C++, Fortran, Pascal, Eiffel, Basic, COBOL, etc., or any of a variety of combinations thereof. The computer-readable medium on which such instructions are stored may reside on one or more of the components of a general-purpose computer described above, and may be distributed across one or more of such components.

The computer-readable medium may be transportable such that the instructions stored thereon can be loaded onto any computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

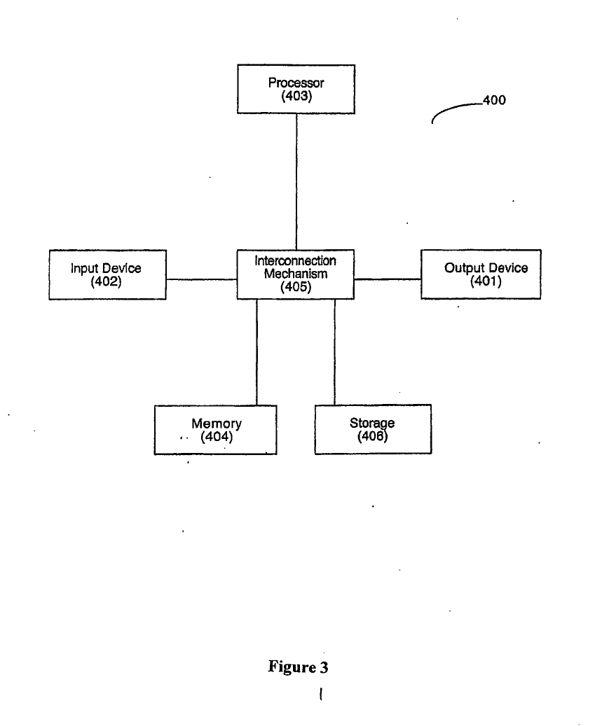

It should be appreciated that any single component or collection of multiple components of a computer system, for example, the computer system described below in relation to FIG. 3, that perform the functions described above with respect to describe or reference the method can be generically considered as one or more controllers that control the above-discussed functions. The one or more controllers can be implemented in numerous ways, such as with dedicated hardware, or using a processor that is programmed using microcode or software to perform the functions recited above.

Another component of the betting system and the computer implemented game method may include a software component (e.g., a driver) that streams video via a broadband, satellite or wireless medium to a user interface. If the game is played completely automatically, the user interface may be merely a video terminal including television with no user input means. Viewing access may be controlled by standard methods for conditional access including using set top box addresses, telephone numbers or internet protocol (IP) addresses.

The above is merely an illustrative embodiment of the betting system and a computer implemented game method. Such an illustrative embodiment is not intended to limit the scope of the invention, as any of numerous other implementations of a betting system and the computer implemented game method, for example, variations of conditional access, are possible and are intended to fall within the scope of the invention. None of the claims set forth below are intended to be limited to any particular implementation of a betting system and a computer implemented game method unless such claim includes a limitation explicitly reciting a particular implementation.

System 300, and components thereof such as the payment, payout and game monitoring system, may be implemented using software (e.g., C, C#, C++, Java, or a combination thereof), hardware (e.g., one or more application-specific integrated circuits, processors or other hardware), firmware (e.g., electrically-programmed memory) or any combination thereof. One or more of the components of system 300 may reside on a single system (e.g., the payment subsystem), or one or more components may reside on separate, discrete systems. Further, each component may be distributed across multiple systems, and one or more of the systems may be interconnected.

Further, on each of the one or more systems that include one or more components of 300, each of the components may reside in one or more locations on the system. For example, different portions of the components of 300 may reside in different areas of memory (e.g., RAM, ROM, disk, etc.) on the system. Each of such one or more systems may include, among other components, a plurality of known components such as one or more processors, a memory system, a disk storage system, one or more network interfaces, and one or more busses or other internal communication links interconnecting the various components.

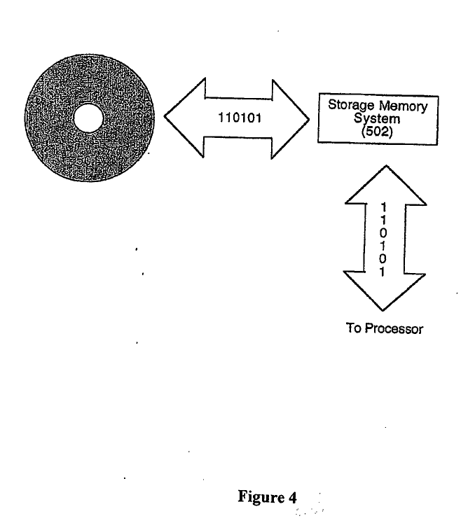

System 300 may be implemented on a computer system described below in relation to FIGS. 3 and 4.

System 300 is merely an illustrative embodiment of the betting system and the computer implemented game method. Such an illustrative embodiment is not intended to limit the scope of the invention, as any of numerous other implementations of the betting system and the computer implemented game method, for example, variations of system 300, are possible and are intended to fall within the scope of the invention. For example, interactive television may also be used to view, make, and submit bets. None of the claims set forth below are intended to be limited to any particular implementation of the betting system unless such claim includes a limitation explicitly reciting a particular implementation.

Various embodiments according to the invention may be implemented on one or more computer systems. These computer systems may be, for example, general-purpose computers such as those based on Intel PENTIUM-type processor, Motorola PowerPC, Sun UltraSPARC, Hewlett-Packard PA-RISC processors, or any other type of processor. It should be appreciated that one or more of any type computer system may be used to partially or fully automate play of the described game according to various embodiments of the invention. Further, the software design system may be located on a single computer or may be distributed among a plurality of computers attached by a communications network.

For example, various aspects of the invention may be implemented as specialized software executing in a general-purpose computer system 400 such as that shown in FIG. 3. The computer system 400 may include a processor 403 connected to one or more memory devices 404, such as a disk drive, memory, or other device for storing data. Memory 404 is typically used for storing programs and data during operation of the computer system 400. Components of computer system 400 may be coupled by an interconnection mechanism 405, which may include one or more busses (e.g., between components that are integrated within a same machine) and/or a network (e.g., between components that reside on separate discrete machines). The interconnection mechanism 405 enables communications (e.g., data, instructions) to be exchanged between system components of system 400. Computer system 400 also includes one or more input devices 402, for example, a keyboard, mouse, trackball, microphone, touch screen, and one or more output devices 401, for example, a printing device, display screen, or speaker. In addition, computer system 400 may contain one or more interfaces (not shown) that connect computer system 400 to a communication network (in addition or as an alternative to the interconnection mechanism 405.

The storage system 406, shown in greater detail in FIG. 4, typically includes a computer readable and writeable nonvolatile recording medium 501 in which signals are stored that define a program to be executed by the processor or information stored on or in the medium 501 to be processed by the program. The medium may, for example, be a disk or flash memory. Typically, in operation, the processor causes data to be read from the nonvolatile recording medium 501 into another memory 502 that allows for faster access to the information by the processor than does the medium 501. This memory 502 is typically a volatile, random access memory such as a dynamic random access memory (DRAM) or static memory (SRAM). It may be located in storage system 406, as shown, or in memory system 404, not shown. The processor 403 generally manipulates the data within the integrated circuit memory 404, 502 and then copies the data to the medium 501 after processing is completed. A variety of mechanisms are known for managing data movement between the medium 501 and the integrated circuit memory element 404, 502, and the invention is not limited thereto. The invention is not limited to a particular memory system 404 or storage system 406.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 400 is shown by way of example as one type of computer system upon which various aspects of the invention may be practiced, it should be appreciated that aspects of the invention are not limited to being implemented on the computer system as shown in FIG. 3. Various aspects of the invention may be practiced on one or more computers having a different architecture or components that that shown in FIG. 3.

Computer system 400 may be a general-purpose computer system that is programmable using a high-level computer programming language. Computer system 400 may be also implemented using specially programmed, special purpose hardware. In computer system 400, processor 403 is typically a commercially available processor such as the well-known Pentium class processor available from the Intel Corporation. Many other processors are available. Such a processor usually executes an operating system which may be, for example, the Windows 95, Windows 98, Windows NT, Windows 2000 (Windows ME) or Windows XP operating systems available from the Microsoft Corporation, MAC OS System X available from Apple Computer, the Solaris Operating System available from Sun Microsystems, or UNIX available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol. Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Having now described some illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

Further, for the one or more means-plus-function limitations recited in the following claims, the means are not intended to be limited to the means disclosed herein for performing the recited function, but are intended to cover in scope any means, known now or later developed, for performing the recited function. In addition, as used herein, whether in the written description or the claims, the terms “comprising”, “including,” “containing,” and the like are to be understood to be open-ended, that is, to mean including but not limited to. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A method of gaming comprising acts of:
defining a casino-related event;
defining odds of the casino-related event occurring; and
recording a bet on whether or not the casino-related event will occur.

2. The method of claim 1, further comprising acts of:
determining if the bet is a winning bet; and
providing a payout for the winning bet based on the defined odds.

3. The method of claim 1, wherein the casino-related event is not game related.

4. The method of claim 1, wherein the casino-related event involves a game offered by a casino.

5. The method of claim 4, wherein the game includes slots.

6. The method of claim 1, wherein the act of recording a bet includes allowing a bettor to place a bet remotely.

7. The method of claim 1, wherein the act of recording a bet includes allowing a bettor to place a bet within a casino.

8. The method of claim 1, wherein the method is a computer-implemented method and the method further comprises performing by a casino event monitoring system acts of:
tracking the casino-related event;
determining if the casino-related event occurred; and
providing a payout to a bettor based on the defined odds.

9. The method of claim 1, further comprising an act of recording a subscription for a bet that allows a bettor to play a particular bet over at least one specified time period.

10. The method of claim 8, further comprising as act of automatically renewing the subscription.

11. The method of claim 1, wherein the act of defining odds of the casino-related event occurring includes an act of adjusting the odds over time.

12. The method according to claim 8, wherein the act of tracking further comprises an act of tracking, by the casino event monitoring system, at least one event determined by playing a slot machine game system.

13. A betting system comprising:
means for defining a casino-related event; and
means for recording a bet related to occurrence of the casino-related event.

14. The betting system of claim 13, wherein the casino-related event is not game related.

15. The betting system of claim 13, wherein the casino-related event involves a game offered by a casino.

16. The betting system of claim 13, wherein the game includes slots.

17. The betting system of claim 13, further comprising means for determining whether the bet is a winning bet.

18. The betting system of claim 13, further comprising means for notifying the bettor of the results of the bet.

19. The betting system of claim 13, further comprising means for subscribing to play a bet for at least one time period.

20. The betting system of claim 13, further comprising means for determining odds of the casino-related event.

21. The betting system of claim 13, further comprising means for submitting a bet proposal by a bettor.

22. The betting system of claim 13, further comprising:
means for tracking the casino-related event;
means for determining if the casino-related event occurred; and
means for providing a payout to a bettor based on defined odds.

23. The betting system of claim 22, wherein tracking further comprises tracking, by a casino event monitoring system, at least one event determined by playing a slot machine game system.

24. A computer-readable medium having computer-readable signals stored thereon that define instructions that, as a result of being executed by a computer, instruct the computer to perform a method of gaming comprising, the method comprising acts of:
defining a casino-related event;
defining odds of the casino-related event occurring; and
recording a bet on whether or not the casino-related event will occur.

25. The computer-readable medium of claim 24, wherein the method of gaming further comprises acts of:
determining if the bet is a winning bet; and
providing a payout for the winning bet based on the defined odds.

26. The computer-readable medium of claim 24, wherein the casino-related event is not game related.

27. The computer-readable medium of claim 24, wherein the casino-related event involves a game offered by a casino.

28. The computer-readable medium of claim 27, wherein the game includes slots.

29. The computer-readable medium of claim 24, wherein the act of recording a bet includes an act of allowing a bettor to place a bet remotely.

30. The computer-readable medium of claim 24, wherein the act of recording a bet includes an act of allowing a bettor to place a bet within a casino.

31. The computer-readable medium of claim 24, wherein the method further comprises, performing by a casino event monitoring system acts of:
tracking the casino related event;
determining if the casino-related event occurred; and
providing a payout to a bettor based on the defined odds.

32. The computer-readable medium of claim 30, wherein the act of tracking further comprises tracking, by the casino event monitoring system, at least one event determined by playing a slot machine gaming system.

33. The computer-readable medium of claim 24, wherein the method further comprises an act of recording a subscription for a bet that allows a bettor to play a particular bet for at least one specified time period.

34. The computer-readable medium of claim 33, wherein the method further comprises an act of automatically renewing the subscription.

35. The computer-readable medium of claim 24, wherein the act of defining odds of the casino-related event occurring includes adjusting the odds over time.
